(19) United States
(12) Patent Application Publication
(10) Pub. No.: US 2019/0311656 A1
(43) Pub. Date: Oct. 10, 2019

(54) Device in format of sticker in different size and forms with video and bendable screen of plasma, with autoadherible material to stick on any surface and transmit synchronized images with mobile devices

(71) Applicant: Carlos Morales Urquiza, Mexico City (MX)

(72) Inventor: Carlos Morales Urquiza, Mexico City (MX)

(21) Appl. No.: 15/731,439

(22) Filed: Jun. 12, 2017

(30) Foreign Application Priority Data
Dec. 1, 2016 (MX) MX/U/2016/000567

(51) Int. Cl. G09F 9/30; G09G 3/28; H02J 7/35

(52) U.S. Cl. CPC G09F 9/301; G09G 3/28; H01J 11/34; G09G 2300/04; G09G 2380/02; H02J 7/355

(57) ABSTRACT

The invention relates to a plasma screen that fits different shapes and measurements, which is foldable, pliable and impermeable, with self-adhesive material for placing on any surface. The device is small, slim, autonomous (does not need to be connected to electricity), pliable, foldable (can be folded), impermeable (resistant to water and inclement weather), easy to stick on any surface and very low cost. The device is interactive and comprises a user terminal (1) that brings together all the parts of the device, the terminal taking the form of different-shaped plastic stickers and containing a foldable plasma screen (2) that covers the circumference of same and transmits images and video. All the parts of the device are connected, by means of small cables (9), to an integrated microcomputer (3) with a processor that contains a computer program, a formula and algorithms that allow information processing and transmission and GPS location. The microcomputer is connected, by means of cables (9), to a wireless modem (4) that allows communication with other mobile devices, and is also connected, by means of cables (9), to a self-recharging battery (5) that powers the device. The microcomputer is connected, by means of cables (9), to solar cells (6) that power the battery (5), without the need for connecting to electricity, making the device autonomous. The front part of the sticker is covered by a transparent plastic fabric (7) that protects the device against rain, grease and other substances and is glued to the monitor (2) covering the circumference and shape of the sticker. The rear part of the sticker is covered by a plastic fabric (8) with self-adhesive material, which can be hung, glued or placed on different surfaces, the fabric being glued to the device.

The present invention relates to: “Device in format of Sticker in different sizes and forms with Video and Bendable Screen of Plasma, with Autoadherible material to stick on any Surface and transmit synchronized images with mobile devices” consisting of a plastic device in the form of Sticker with Glue Cloth Which contains a Plasma Screen with Internet, NFC, Bluetooth, GPS access, Panels Solar and a self-rechargeable battery. The Characteristics of our development is that the stickers are Small, Slim, Standalone (do not require Connect to current Electric), Malleable, Foldable (can be folded), waterproof (ie Resist water), are easy to stick on any surface and are Extraordinarily low cost.

The novelty is that there is nowhere in the world a with Plasma Screen that conforms to measurements and various figures such as a Giraffe Baby, which are Foldable, malleable and Waterproof with Self Adhesive Material to fit in any surface.

### BACKGROUND

There are currently and past plastic stickers that stick on either surface, Which by their nature are small and generally contain figures and color of animals or diverse advertising, However, no one Contains a video screen that can be folded or that suits as ex. the case of a Sticker with Video Screen in the shape of an elephant, taking into account that Video screens are usually Rectangular and do not conform to a specific form, nor do they Can fold.

Mobile Display Device Synchronization Technology is extremely common, however, it does not exist anywhere on the World, self-adhering stickers that allow video transmission selected by the user on their mobile device.

The advantage of being able to place these stickers in Clothing, Refreshment Bottles, Coolers, Backpacks, Notebooks, Lockers, Walls, Glass, Mirrors, and Generally in any place, is that it allows to direct publicity and Messages to a preselected group of people, same images and Videos that can be manipulated and modified from the mobile device user,

In other words, Ex. Some Beverage companies give personal names to their Bottles on labels, but with our development, they will be able to direct Personalized advertising on Soda bottles to people who Go through the Supermarket aísles.

Users can be anyone who acquires our e-Stickers at a low price. Imagine that you are passing through the aisle of a Supermarket and a Product “x” or a Refreshment, it says “hello Pepe, Buy me”

RFID chips are now in fashion, many companies have tried to place them on the supermarket sale products, however, the e-Stickers offer a low cost alternative thanks to the and the widespread use of GPS and Hot Spots Logistics.

### BRIEF DESCRIPTION OF THE INVENTION

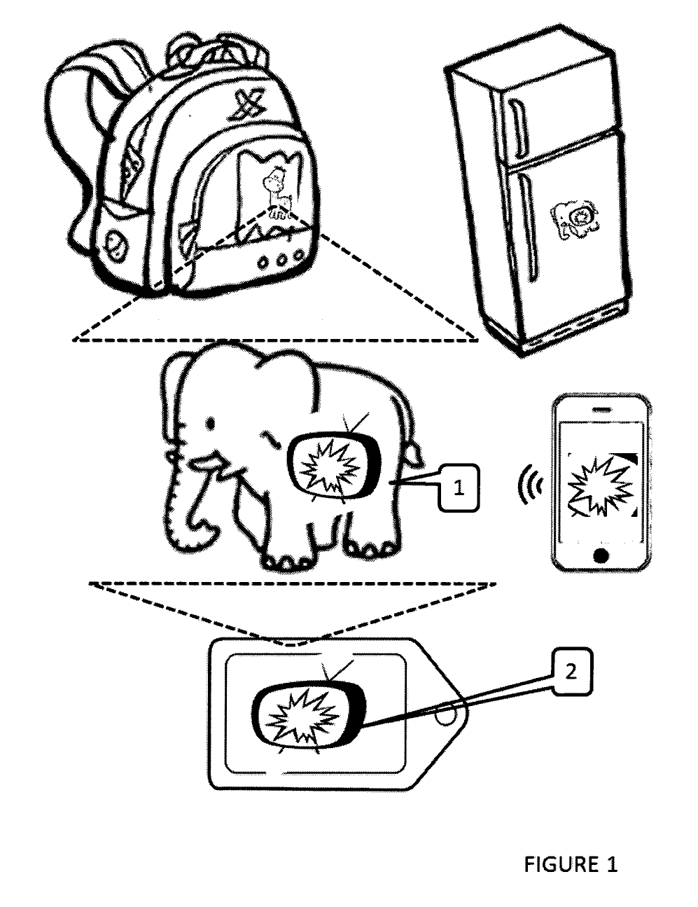

FIG. 1 shows an Outline view of the “Device in format of Sticker in different sizes and forms with Video and Bendable Screen of Plasma, with Autoadherible material to stick on any Surface and transmit synchronized images with mobile devices”

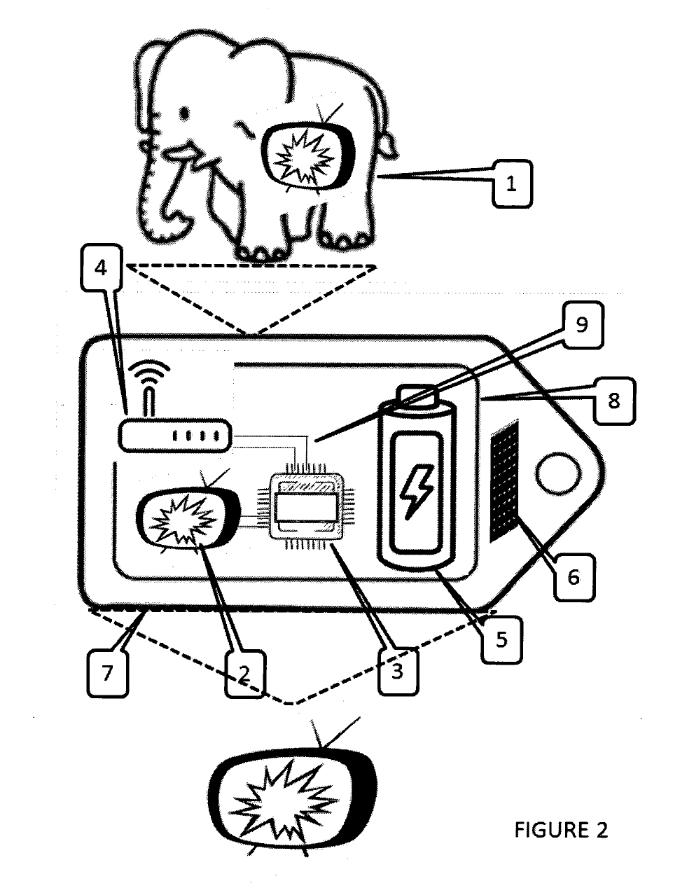

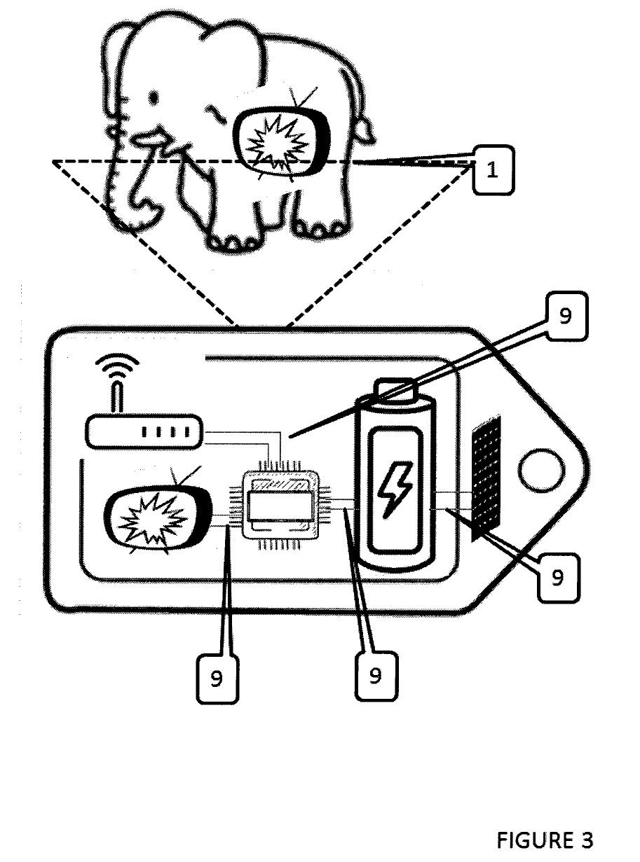

FIG. 2 shows an inside view of the elements and parts, which are connected through Cables, etc., as shown in FIG. 3.

### DETAILED DESCRIPTION OF THE INVENTION

The “Device in format of Sticker in different sizes and forms with Video and Bendable Screen of Plasma, with Autoadherible material to stick on any Surface and transmit synchronized images with mobile devices” consists of: A User Terminal (1) that performs the function of Consolidate all parts of the Device, same Terminal in Various forms of Plastic stickers, which contains a Plasma Foldable Display Screen covering the circumference of the same (2) Which performs the function of Transmit Images and Video, All Parts of the Device are connected via Small cables to a Micro Computer with Processor (3) Which contains a Program of Computation, Formula and Algorithms that Allow to Perform the function of Processing and Transmitting Information, GPS, which connects to a wireless modem (4) which enables to Perform the function of communication with other mobile devices, itself Which connects to an Auto Rechargeable Battery (5) Which performs the function to provide power to the same connecting device, which Connects to Solar Cells (6) Which performs the function of Providing Energy to the Battery (5) Without requiring to connect to electric current outlet, which makes Autonomous device.

The front of the e-Sticker is covered with a transparent plastic cloth (7) Which performs the function of protecting the device against Rain, grease and others. The rear part of the e-Sticker is covered by A Plastic Fabric with self-adhering material (8), Which performs the function of Hang, glue or place on any surface.

This Device fulfills the function of providing Ad-Hoc Advertising Customized to the step of the Persons with whom it is desired to position a Product or simply a note, image or video.

This device fulfills the function of being autonomous and able to stick Anywhere.

### SUMMARY

“Plasma screen that conforms to measurements and various figures as Foldable, Malleable and Waterproof with Self Adhesive Material to Place On any surface, whether small, thin, autonomous (not Required to be connected to electric outlet), malleable, (Can fold), impermeable (ie resist water and inclemencies), Easy to glue on any surface and are extraordinarily manufactured at a very low cost” Which is an interactive device Consisting of User Terminal (1) that performs the function of Consolidate all parts of the Device, same Terminal in Various forms of Plastic stickers, which contains a Plasma Foldable Display Screen covering the circumference of the same (2) Which performs the function of Transmit Images and Video, All Parts of the Device are connected via Small cables to a Micro Computer with Processor (3) Which contains a Program of Computation, Formula and Algorithms that Allow to Perform the function of Processing and Transmitting Information, GPS, which connects to a wireless modem (4) which enables to Perform the function of communication with other mobile devices, itself Which connects to an Auto Rechargeable Battery (5) Which performs the function to provide power to the same connecting device, which Connects to Solar Cells (6) Which performs the function of Providing Energy to the Battery (5) Without requiring to connect to electric current outlet, which makes Autonomous device.

The front of the e-Sticker is covered with a transparent plastic cloth (7) Which performs the function of protecting the device against Rain, grease and others. The rear part of the e-Sticker is covered by A Plastic Fabric with self-adhering material (8), Which performs the function of Hang, glue or place on any surface.

This Device fulfills the function of providing Ad-Hoc Advertising Customized to the step of the Persons with whom it is desired to position a Product or simply a note, image or video.

This device fulfills the function of being autonomous and able to stick Anywhere.

Having described the apparatus as above, I consider it a novelty and So I relay my property contained in the following clause:

1. The “Device in format of Sticker in different sizes and forms with Video and Bendable Screen of Plasma, with Autoadherible material to stick on any Surface and transmit synchronized images with mobile devices” Also called as:
“Plasma screen that conforms to measurements and various figures as Foldable, Malleable and Waterproof with Self Adhesive Material to Place On any surface, whether small, thin, autonomous (not Required to be connected to electric outlet), malleable, (Can fold), impermeable (ie resist water and inclemencies), Easy to glue on any surface and are extraordinarily manufactured at a very low cost” Which is an interactive device Consisting of User Terminal (1) that performs the function of Consolidate all parts of the Device, same Terminal in Various forms of Plastic stickers, which contains a Plasma Foldable Display Screen covering the circumference of the same (2) Which performs the function of Transmit Images and Video, All Parts of the Device are connected via Small cables to a Micro Computer with Processor (3) Which contains a Program of Computation, Formula and Algorithms that Allow to Perform the function of Processing and Transmitting Information, GPS, which connects to a wireless modem (4) which enables to Perform the function of communication with other mobile devices, itself Which connects to an Auto Rechargeable Battery (5) Which performs the function to provide power to the same connecting device, which Connects to Solar Cells (6) Which performs the function of Providing Energy to the Battery (5) Without requiring to connect to electric current outlet, which makes Autonomous device.
The front of the e-Sticker is covered with a transparent plastic cloth (7) Which performs the function of protecting the device against Rain, grease and others. The rear part of the e-Sticker is covered by A Plastic Fabric with self-adhering material (8), Which performs the function of Hang, glue or place on any surface.
This Device fulfills the function of providing Ad-Hoc Advertising Customized to the step of the Persons with whom it is desired to position a Product or simply a note, image or video.
This device fulfills the function of being autonomous and able to stick Anywhere.
